(19) United States
(12) Patent Application Publication
(10) Pub. No.: US 2026/0131778 A1
(43) Pub. Date: May 14, 2026

(54) BRAKE SYSTEM AND METHOD CONTROLLING THE SAME

(71) Applicant: HL MANDO CORPORATION, Pyeongtaek-si (KR)

(72) Inventor: Jaehoon JANG, Pyeongtaek-si (KR)

(73) Assignee: HL MANDO CORPORATION, Pyeongtaek-si (KR)

(21) Appl. No.: 19/368,946

(22) Filed: Oct. 24, 2025

(30) Foreign Application Priority Data
Nov. 13, 2024 (KR) 10-2024-0161380
Aug. 18, 2025 (KR) 10-2025-0114068

(51) Int. Cl. B60T 17/22; B60T 8/171; B60T 8/172; B60T 13/74; F16D 65/38

(52) U.S. Cl. CPC B60T 17/22; B60T 8/171; B60T 8/172; B60T 13/746; F16D 65/38; F16D 2065/386

(57) ABSTRACT

A brake system and a method for controlling the same are disclosed. According to one aspect of the disclosed invention, a brake system for controlling an EMB (Electro Mechanical Brake), which is provided on a vehicle's wheel to provide braking force to the wheel, includes: a brake pad that applies frictional force to a disk provided on the wheel; a motor that moves the brake pad; and a controller that controls the operation of the motor based on receiving a control command signal. The controller controls the rotation of the motor by outputting a control signal to the motor corresponding to at least one of braking force control, disk-pad distance control, and parking control, based on receiving the control command signal. Furthermore, the controller can determine the application of at least one of F/F control (Feed Forward Control) and F/B control (Feed Back Control).

### CROSS-REFERENCE TO RELATED APPLICATION

This application claims the benefit of Korean Patent Application No. 10-2024-0161380, filed on Nov. 13, 2024, in the Korean Intellectual Property Office and Korean Patent Application No. 10-2025-0114068, filed on Aug. 18, 2025, in the Korean Intellectual Property Office, the disclosure of which is incorporated herein by reference.

### TECHNICAL FIELD

The disclosed invention relates to a brake system and its control method. Specifically, it concerns a brake system and its control method that perform braking force control for Force Tracking, disc-pad distance control for Zero Drag, and parking control. It also evaluates the reliability of the PID (Proportional Integral Derivative) controller for each element (braking force control, disc-pad distance control, and parking control) to determine whether to perform a hybrid control of F/F control (Feed Forward Control) and F/B control (Feed Back Control).

### BACKGROUND

A vehicle is mandatorily equipped with a brake system for braking, and various types of brake systems have been proposed for the safety of the driver and passengers.

Conventional brake systems have widely developed and are currently using Electro-Mechanical Brakes (EMB), which receive the driver's braking intention as an electrical signal and, based on it, operate an electric motor or similar device to provide the vehicle's braking force.

Meanwhile, in the EMB system, the clamping force estimator is the most crucial element in Sensorless control, and it is a very difficult technology. In some situations, its estimation reliability deteriorates due to very complex reasons. In conventional EMB systems, under ideal conditions (e.g., normal temperature and general braking), the estimation results do not have a large error from the estimation situation measured in a conventional lab. However, there has been a problem where the reliability of the estimation performance is degraded due to the condition of the pad being different from the ideal situation through continuous ABS (Anti-lock Braking System) or ESC (Electronic Stability Control) situations, or due to severe error in the pad's rigidity itself from the existing reference data (measurement data from a lab) due to extremely low temperatures.

### BRIEF SUMMARY

One aspect of the disclosed invention is to provide a brake system and its control method that, when the reliability of the estimation performance degrades, converts the controller to Feedforward (F/F) control through a separate notification to separate estimation performance from control performance. It then re-applies the Feedforward control together with Feedback (F/B) control when reliability is recovered.

According to one aspect of the disclosed invention, a brake system for controlling an EMB (Electro Mechanical Brake) installed on a vehicle's wheel to provide braking force to the wheel includes: a brake pad that applies friction to a disc installed on the wheel; a motor that moves the brake pad; and a controller that controls the operation of the motor based on receiving a control command signal. The controller, based on receiving the control command signal, can output a control signal corresponding to at least one of braking force control, disc-pad distance control, and parking control to the motor to control the rotation of the motor, and can determine the application of at least one of F/F control (Feed Forward Control) and F/B control (Feed Back Control).

According to one aspect of the disclosed invention, the controller can evaluate the reliability of the F/B control, and if the reliability is less than a preset threshold, it can limit the control by the F/B control.

According to one aspect of the disclosed invention, while the F/B control is limited, the controller can re-evaluate the reliability, and as a result of the re-evaluation, if the reliability is greater than or equal to a preset threshold, it can release the limitation of the F/B control.

According to one aspect of the disclosed invention, the controller can evaluate the reliability of the F/B control, and if the reliability is less than a preset threshold, it can apply only the control by the F/F control.

According to one aspect of the disclosed invention, while the F/F control is being performed with the F/B control limited, the controller can re-evaluate the reliability, and as a result of the re-evaluation, if the reliability is greater than or equal to a preset threshold, it can apply the F/F control and the F/B control.

According to one aspect of the disclosed invention, the controller can evaluate the reliability based on a target braking force corresponding to the control command signal and an estimated braking force corresponding to the control signal.

According to one aspect of the disclosed invention, the controller can perform an update for at least one of the F/F control and the F/B control to: obtain a first output by performing the F/F control corresponding to the control command signal; obtain a second output by performing the F/B control corresponding to the control command signal; generate the control signal based on the first output and the second output; limit the upper and lower bounds of the accumulated control signal; and adjust the error caused by the F/B control.

According to one aspect of the disclosed invention, in the disc-pad distance control, the controller can perform position control for the position of the brake pad, and if first error data corresponding to an error through the position control is generated, it can perform speed control for the motor based on the first error data.

According to one aspect of the disclosed invention, if second error data corresponding to an error through the speed control is generated, it can perform torque control for the motor based on the second error data.

According to one aspect of the disclosed invention, in the parking control, the controller can control the motor to stop the vehicle, and if a fault is identified, it can control the motor to re-perform the parking control. In the parked state of the vehicle, if the rotation of the wheel is identified or the clamping force by the brake pad is less than a threshold, the controller can release the parked state of the vehicle and control the motor to re-perform the parking control.

According to one aspect of the disclosed invention, a control method for a brake system for controlling an EMB (Electro Mechanical Brake) installed on a vehicle's wheel to provide braking force to the wheel, including a brake pad that applies friction to a disc installed on the wheel, a motor that moves the brake pad, and a controller that controls the operation of the motor based on receiving a control command signal, may include: based on receiving a control command signal, outputting a control signal corresponding to at least one of braking force control, disc-pad distance control, and parking control to the motor to control the rotation of the motor; and determining the application of at least one of F/F control (Feed Forward Control) and F/B control (Feed Back Control).

According to one aspect of the disclosed invention, determining the application may further include: evaluating the reliability of the F/B control, and if the reliability is less than a preset threshold, limiting the control by the F/B control.

According to one aspect of the disclosed invention, the control method of the brake system may further include: while the F/B control is limited, re-evaluating the reliability, and as a result of the re-evaluation, if the reliability is greater than or equal to a preset threshold, releasing the limitation of the F/B control.

According to one aspect of the disclosed invention, determining the application may further include: evaluating the reliability of the F/B control, and if the reliability is less than a preset threshold, applying only the control by the F/F control.

According to one aspect of the disclosed invention, the control method of the brake system may further include: while the F/F control is being performed with the F/B control limited, re-evaluating the reliability, and as a result of the re-evaluation, if the reliability is greater than or equal to a preset threshold, applying the F/F control and the F/B control.

According to one aspect of the disclosed invention, the reliability may be evaluated based on the target braking force corresponding to the control command signal and the estimated braking force corresponding to the control signal.

According to one aspect of the disclosed invention, controlling the rotation of the motor may further include: performing the F/F control corresponding to the control command signal to obtain a first output; performing the F/B control corresponding to the control command signal to obtain a second output; generating the control signal based on the first output and the second output; limiting the upper and lower bounds of the accumulated control signal; and performing an update for at least one of the F/F control and the F/B control to adjust the error caused by the F/B control.

According to one aspect of the disclosed invention, controlling the rotation of the motor may further include: in the disc-pad distance control, performing position control for the position of the brake pad, and if first error data corresponding to an error through the position control is generated, performing speed control for the motor based on the first error data.

According to one aspect of the disclosed invention, performing the speed control may further include: if second error data corresponding to an error through the speed control is generated, performing torque control for the motor based on the second error data.

According to one aspect of the disclosed invention, controlling the rotation of the motor may further include: in the parking control, controlling the motor to stop the vehicle, and if a fault is identified, controlling the motor to re-perform the parking control; and in the parked state of the vehicle, if the rotation of the wheel is identified or the clamping force by the brake pad is less than a threshold, releasing the parked state of the vehicle and controlling the motor to re-perform the parking control.

According to one aspect of the disclosed invention, the brake system and its control method avoid a decline in the quality of the EMB's own control performance by separating the control performance and tracking performance when the performance of the estimator degrades.

### BRIEF DESCRIPTION OF THE SEVERAL VIEWS OF THE DRAWINGS

These and/or other aspects of the disclosure will become apparent and more readily appreciated from the following description of the embodiments, taken in conjunction with the accompanying drawings of which:

FIG. 1 briefly illustrates the configuration of a brake system according to one embodiment;

FIG. 2 illustrates the basic control flow of a brake system according to one embodiment;

FIG. 3 illustrates the reliability evaluation flow of a brake system according to one embodiment;

FIG. 4 illustrates an exemplary diagram of displacement variation in a rig environment of a brake system according to one embodiment; and

FIG. 5 illustrates an exemplary diagram of reliability variation in a rig environment of a brake system according to one embodiment.

### DETAILED DESCRIPTION

Throughout the specification, identical reference numerals refer to identical components. This specification does not describe all elements of the embodiments, and common content in the technical field to which the disclosed invention pertains or redundant content between embodiments is omitted. The terms ‘unit, module, member, block’ used in the specification can be implemented in software or hardware, and depending on the embodiments, a plurality of ‘units, modules, members, blocks’ can be implemented as a single component, or a single ‘unit, module, member, block’ can include a plurality of components.

Throughout the specification, when a part is said to be ‘connected’ to another part, it includes not only cases where it is directly connected, but also cases where it is indirectly connected, and indirect connections include being connected via a wireless communication network.

Also, when a part is said to ‘comprise’ a certain component, it means that it may further include other components, unless there is a specific description to the contrary, which excludes other components.

Throughout the specification, when a member is said to be located ‘on’ another member, it includes not only cases where the member is in contact with the other member, but also cases where another member exists between the two members.

Terms such as first, second, etc., are used to distinguish one component from another, and the components are not limited by the terms mentioned above.

The singular expression includes the plural expression unless the context clearly dictates otherwise.

The identifiers in each step are used for convenience of description and do not describe the order of each step, and each step can be implemented differently from the specified order unless a specific order is clearly stated in the context.

The vehicle (1) may include a body that forms its exterior and accommodates a driver and/or luggage, a chassis that includes components of the vehicle (1) other than the body, and wheels that rotate to allow the vehicle (1) to move.

For example, each of the wheels may be provided with a disc that is coupled with and rotates with the wheels. Additionally, each of the wheels may be provided with a brake caliper that can inhibit the rotation of the disc using friction. For example, the brake caliper can brake the rotation of the wheels and the disc by using friction between a brake pad included in the brake caliper and the disc.

The brake caliper may be provided with Electric Mechanical Brakes (EMB) (130) that move the brake pads to press the disc using electro-mechanical force without a pressure medium. The EMB (130) can be a device that integrates Service Brake and Parking Brake to brake and/or stop the vehicle (1) in response to a driver's parking command via a parking switch or a handbrake, and can operate as a parking brake.

The EMB (130), installed on the wheel of the vehicle (1) to provide braking force to the wheel, may include a parking brake actuator (not shown), such as an electro-mechanical actuator. The electro-mechanical actuator may include devices that generate physical force to brake the vehicle (1) without a pressure medium. For example, the electro-mechanical actuator may include a motor (131) and/or a power transmission device (e.g., gear, pulley/belt, spindle/nut, etc.).

Hereinafter, the operating principles and embodiments of the disclosed invention will be described with reference to the attached drawings.

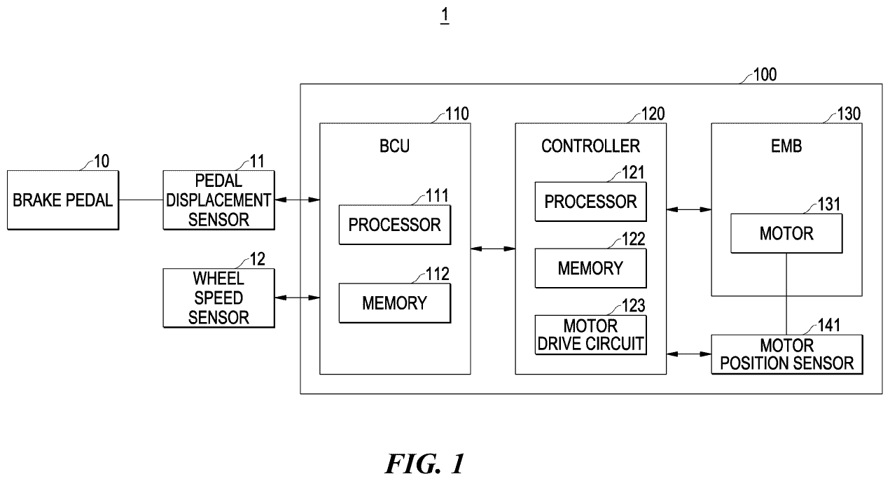

FIG. 1 briefly illustrates the configuration of a brake system according to one embodiment.

The brake system (100) may include a parking brake actuator that drives a parking brake provided in a wheel brake, and a BCU (110) (Brake Control Unit) and/or a controller (120) that controls the parking brake actuator based on a braking command signal and/or a parking command signal.

Although not shown, the BCU (110) may include one or more semiconductor devices and can be integrated, separated, or partitioned with the controller (120). The controller (120) may include one or more semiconductor devices and can be variously referred to as an ECU (Electronic Control Unit), etc.

As shown in FIG. 1, the BCU (110) may include, for example, one or more processors (111) and/or one or more memories (112). The processor (111) controls the overall operation of the BCU (110), and the memory (112) can store/save programs and data for braking the vehicle (1) based on the user's braking intention and/or the rotational speed of the wheels (FL, FR, RL, RR). The memory (112) provides programs and data to the processor (111) and can store temporary data generated during the processor's (111) computation. The memory (112) may include volatile memories (112) such as Static Random Access Memory (S-RAM) and Dynamic Random Access Memory (D-RAM), and non-volatile memories such as Erasable Programmable Read Only Memory (EPROM) and flash memory.

The parking command signal can be provided to the controller (120) from various signal sources. For example, the parking command signal can be provided directly to the controller (120) from a parking switch, a transmission controller, or a central controller of the vehicle (1), and/or can be provided to the controller (120) via the BCU (110) (Brake Control Unit) from the central controller.

Referring to FIG. 1, as an example, the BCU (110) and the controller (120) of the brake system (100) can be separated, partitioned, or integrated. The BCU (110) can be physically or circuitously separated from the controller (120). For example, the BCU (110) can be located on the same printed circuit board as the controller (120) but in different, separated areas. As shown in FIG. 1, the controller (120) can be connected to the BCU (110) through a data line (e.g., automotive communication network, conductive line, etc.). In this way, the BCU (110) and the controller (120) can exchange data, signals, and/or messages with each other through the data line.

For example, when the BCU (110) and the controller (120) are separated or partitioned, the controller (120) may be a separate control module provided for each of the EMBs (130). When the BCU (110) and the controller (120) are integrated, the controller (120) may be a control module that performs integrated control of the brake system (100).

The controller (120) can receive a parking command signal to park or unpark the vehicle (1), and can control the parking brake actuator to park or unpark the vehicle (1) based on the parking command signal.

The driver can operate a parking switch for parking (e.g., by pressing the parking switch), and the parking switch can provide a parking command signal to the controller (120) based on the driver's operation. The driver can position the shift lever to “Park” for parking, and the transmission controller can provide a parking command signal to the controller (120) based on the driver's operation. Additionally, the driver can turn off the ignition or get out of the vehicle after parking, and the central controller of the vehicle (1) can provide a parking command signal to the controller (120) of the brake system (100) upon ignition off or the driver's exit.

The parking command signal can be a toggle signal based on the current state of the parking brake. For example, if the parking brake is released, the parking command signal includes a command to park the vehicle (1), and if the parking brake is engaged, the parking command signal may include a command to unpark the vehicle (1).

As described above, the vehicle (1) may be provided with a plurality of wheels (FL, FR, RL, RR). For example, the plurality of wheels (FL, FR, RL, RR) may include a wheel (FL) provided on the front left of the vehicle (1), a wheel (FR) provided on the front right of the vehicle (1), a wheel (RL) provided on the rear left of the vehicle (1), and a wheel (RR) provided on the rear right of the vehicle (1).

A parking brake actuator may be provided for each of the plurality of wheels (FL, FR, RL, RR). Depending on the operation of each of the parking brake actuators, the parking brake can be engaged or released on the plurality of wheels (FL, FR, RL, RR). The parking brake actuators are not limited to four. For example, the parking brake actuators may be provided in the same number as the number of wheels on the vehicle (1) or may not be provided on some auxiliary wheels, and are not limited thereto.

The brake system (100) can control the operation of each of the parking brake actuators.

An example of the brake system (100) may include the BCU (110), the controller (120), and the EMB (130). However, the BCU (110), the controller (120), and the EMB (130) do not constitute the necessary and sufficient configuration of the brake system (100), and at least some of them may be omitted or other components may be added.

The parking brake actuator can correspond to an electro-mechanical actuator. The parking brake actuator can be operated by the control signal and/or driving current of the controller (120). For example, the parking brake actuator may include the motor (131) and a power transmission device that are controlled or driven by the controller (120).

The parking brake actuator is provided on at least some or all of the wheels (FL, FR, RL, RR) and can drive the rotation of the wheels (FL, FR, RL, RR). For example, the parking brake actuator can restrict the rotation of the wheel where the parking brake actuator is provided. The parking brake actuator may include a motor (131), and the torque provided by the motor (131) in the parking brake actuator can be converted into a translational movement that moves the brake pad towards the disc by a spindle.

Furthermore, the brake system (100) and/or the vehicle (1) may include a pedal displacement sensor (11), a wheel speed sensor (12), and/or a motor position sensor (141), and may further include a clamping force sensor (not shown) and/or a wheel brake pressure sensor (not shown).

The vehicle (1) may include a brake pedal (10), and the pedal displacement sensor (11) can sense the movement of the brake pedal (10). The pedal displacement sensor (11) can provide a pedal signal representing the displacement and/or speed of movement of the brake pedal (10) to the controller (120). Specifically, the pedal displacement sensor (11) can sense the movement of the brake pedal (10) that moves based on the user's braking intention, and can output an electrical signal (e.g., voltage signal or current signal) (hereinafter referred to as ‘pedal signal’) that depends on the travel distance and/or speed of the brake pedal (10) to the controller (120).

The wheel speed sensor (12) is provided on each of the wheels (FL, FR, RL, RR) of the vehicle (1) and can sense the rotation and/or rotational speed of the wheels (FL, FR, RL, RR) due to the vehicle's travel. The wheel speed sensor (12) can provide an electrical signal (e.g., voltage signal or current signal) (hereinafter referred to as ‘wheel speed signal’) corresponding to the rotational speed of the wheels (FL, FR, RL, RR) to the controller (120) of the brake system (100).

During feedforward control of the motor (131), the motor position can increase steadily, and the boost amount can also increase steadily. The motor position sensor (141) can provide an electrical signal (e.g., voltage signal or current signal) (hereinafter referred to as ‘motor position signal’) corresponding to this position of the motor (131) to the controller (120) of the brake system (100).

The clamping force sensor can be provided inside the caliper piston of the brake caliper, near the caliper piston, or near the housing of the brake caliper or the brake pad, and can provide an electrical signal (e.g., voltage signal or current signal) (hereinafter referred to as ‘clamping force signal’) corresponding to the force pressing the disc (the braking force of the parking brake) to the controller (120) of the brake system (100).

The wheel brake pressure sensor can be provided in the brake caliper and can measure the braking force provided to the brake caliper pressure. The wheel brake pressure sensor can output an electrical signal (e.g., voltage signal or current signal) (hereinafter referred to as ‘pressure signal’) corresponding to the measured pressure to the controller (120).

The pedal displacement sensor (11), the wheel speed sensor (12), the motor position sensor (141), the clamping force sensor, and/or the wheel brake pressure sensor do not constitute the necessary and sufficient configuration of the brake system (100), and at least some of them may be omitted or other components may be added.

Meanwhile, the controller (120) can receive the pedal signal from the pedal displacement sensor (11) and can control the parking brake actuator to brake the vehicle (1) based on the pedal signal.

The controller (120) can receive a pedal signal indicating the user's braking intention from the pedal displacement sensor (11). The pedal displacement sensor (11) can sense the movement of the brake pedal (10) that moves based on the user's braking intention, and can output an electrical signal (pedal signal) that depends on the travel distance and/or speed of the brake pedal (10). The controller (120) can provide an electrical signal for the forward or backward movement of the brake pad to the motor (131) in the parking brake actuator in response to the pedal signal.

Meanwhile, the BCU (110) and/or the controller (120) can receive power from the power source of the vehicle (1).

In one embodiment, the controller (120) can provide a driving voltage, driving current, and/or driving power to the motor (131) in the parking brake actuator to control the Clamping Force of the brake pad on the disc in response to the pedal signal from the pedal displacement sensor (11), the wheel speed signal from the wheel speed sensor (12), the motor position signal from the motor position sensor (141), the clamping force signal from the clamping force sensor, and/or the pressure signal from the wheel brake pressure sensor.

As shown in FIG. 1, the controller (120) may include, for example, one or more processors (121) and/or one or more memories (122).

In one embodiment, the controller (120) may include a processor (121), a memory (122), and/or a motor drive circuit (123). The processor (121), the memory (122), and the motor drive circuit (123) do not constitute the essential components of the controller (120), and at least some of them may be omitted.

The motor drive circuit (123) can receive a control signal from the processor (121) and provide a driving current to the motor (131) of the parking brake actuator to engage the parking brake based on the control signal (e.g., engagement/release signal) from the processor (121).

The processor (121) can process the output signals from the clamping force sensor, the wheel speed sensor (12), the wheel brake pressure sensor, and the pedal displacement sensor (11), and can control the motor (131) of the parking brake actuator based on processing the output signals.

The processor (121) may include a single semiconductor device or a plurality of semiconductors. The processor (121) may include a single core or a plurality of cores inside the semiconductor device. Also, the processor (121) can be variously referred to as an MCU (Micro Controller Unit), etc.

Additionally, the controller (120) and/or the processor (121) may include a memory (122) that stores/saves programs and data for braking the vehicle (1) based on the user's braking intention and/or stopping (parking) intention and/or the rotational speed of the wheels (FL, FR, RL, RR). The memory (122) provides programs and data to the processor (121) and can store temporary data generated during the processor's (121) computation. The memory (122) may include volatile memories (122) such as Static Random Access Memory (S-RAM) and Dynamic Random Access Memory (D-RAM), and non-volatile memories (122) such as Erasable Programmable Read Only Memory (EPROM) and flash memory (122).

The processor (121) can receive a braking command signal to decelerate the vehicle (1) and/or a parking command signal to park or unpark the vehicle (1). The braking command signal can be a pedal signal indicating the user's braking intention. The parking command signal can be provided to the processor (121) from a parking switch, a transmission controller, or a central controller of the vehicle (1). The parking command signal can be a toggle signal based on the state of the parking brake actuator. For example, during the release of the parking brake, the parking command signal can indicate an engagement command for the parking brake, and during the engagement of the parking brake, the parking command signal can indicate a release command for the parking brake. The processor (121) can provide a control signal to the motor drive circuit (123) to engage or release the parking brake based on the parking command signal.

If a parking command signal is received while the vehicle is stopped, the processor (121) can provide a control signal to the motor drive circuit (123) to engage or release the parking brake based on whether the parking brake is engaged. Unlike when a parking command signal is received while stopped, if a parking command signal is received while driving, the processor (121) can provide a control signal to the motor drive circuit (123) to engage the parking brake while the valid parking command signal is being received. If the reception of the valid parking command signal is stopped, the processor (121) can provide a control signal to the motor drive circuit (123) to release the parking brake.

The braking of the vehicle (1) by the parking command signal while the vehicle (1) is driving can continue as long as the reception of the parking command signal continues. For example, if the driver presses the parking switch while the vehicle (1) is driving, the brake system (100) can use the parking brake actuator to brake the vehicle (1). If the driver stops pressing the parking switch before the vehicle (1) stops (or before the vehicle's (1) driving speed becomes less than a reference speed), the brake system (100) can stop braking the vehicle (1).

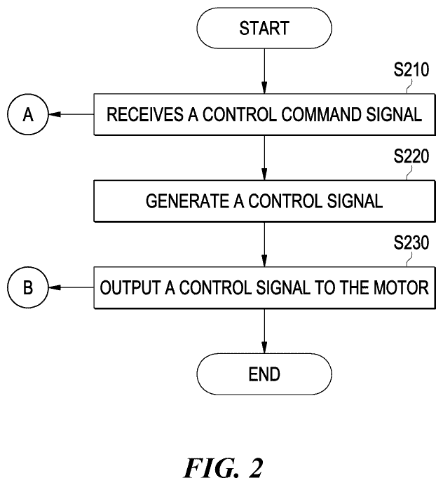

FIG. 2 illustrates the basic control flow of a brake system according to one embodiment.

As shown in FIG. 2, in the brake system (100) that controls the EMB (130), when the controller (120) receives a control command signal (S210), it can generate a control signal (S220) to perform at least one of braking force control, disc-pad distance control, and parking control based on receiving the control command signal.

The control command signal may include a braking command signal and/or a parking command signal.

As an example, the controller (120) can perform control based on a PID (Proportional Integral Derivative) controller. The PID controller can perform at least one of braking force control, disc-pad distance control, and parking control. The PID controller may be a control algorithm pre-stored in the memory (122) and may be one of various conventional feedforward control algorithms. The PID controller can perform feedback control of the motor (131) so that the current speed of the motor (131) tracks the target speed. For example, the PID controller can determine the output, which is the sum of a first output (first torque of the motor (131)) based on control based on a required target output (e.g., target rotational speed) according to a target braking force corresponding to the control command signal, and a second output (second torque of the motor (131)) based on feedback control, as the torque of the motor (131). The PID controller can output a control signal corresponding to the determined torque.

The processor (121), based on the control command signal, can generate a control signal to perform at least one of disc-pad distance control and parking control based on the PID controller.

The controller (120) can control the rotation of the motor (131) by outputting a control signal to the motor (131) (S230) provided in the parking brake actuator. The controller (120) can perform control over the deceleration, stopping, parking, or unparking state of the vehicle (1) by making the brake pad perform translational motion through the rotation of the motor (131).

The processor (121) can control the driving current provided to the motor (131) based on the control signal.

Meanwhile, the controller (120) can perform F/F control (Feed Forward Control) to estimate a target output corresponding to the control command signal.

For this purpose, the processor (121) can perform control based on the PID controller. Specifically, the processor (121) can obtain a first output by estimating the required target output corresponding to the control command signal through F/F control.

The F/F control can be based on the following Equation 1.

$${u}_{ff} ( t ) = {G}_{ff} ( s ) \times {Y}_{ref} ( t ) \qquad [ Equation 1 ]$$

u_{ff}(t) is the control signal from F/F control corresponding to time (t), G_{ff}(s) is a variable based on the system's dynamic characteristics(s), and Y_{ref}(t) is the target output estimated by a matching method and a Kalman Filter based on the current state of the parking brake actuator, evaluated estimation reliability, motor torque, and position information. The target output will be detailed in the following Equation 7.

Additionally, the controller (120) can perform F/B control (Feed Back Control) for the control command signal. The processor (121) can perform F/B control to obtain a second output. The F/B control can be based on the following Equation 2.

$${u}_{fb} ( t ) = {K}_{p} e ( t ) + {K}_{i} l ( t ) + {K}_{d} \frac{de ( t )}{dt} \qquad [ Equation 2 ]$$

u_{fb}(t) is the control signal by F/B control corresponding to time, Kₚ, Kᵢ, and K_{d} are the gain values, respectively, e(t) is the error, and l(t) is defined as

$${\int }_{o}^{t} e ( τ ) d τ .$$

The controller (120) can generate a control signal based on the first and second outputs. The controller (120) can perform updates on at least one of the F/F control and the F/B control to limit the upper and lower bounds of the accumulated control signal and to adjust for error.

The processor (121) can generate a control signal to drive the motor (131) to the target output based on the sum of the first and second outputs. Additionally, the processor (121) can limit the accumulated value of the control signal based on a preset upper limit and a preset lower limit.

The accumulated control signal can be expressed as in the following Equation 3, reflecting physical limits.

$${u}_{sat} ( t ) = sat ( u ( t ) ) = max ( {u}_{min} , min ( u ( t ) , {u}_{max} ) ) \qquad [ Equation 3 ]$$

uₛₐₜ(t) is the accumulated control signal, sat(u(t)) is the saturation value of the control signal, uₘᵢₙ is the lower limit of the accumulated control signal, and uₘₐₓ is the upper limit of the accumulated control signal.

The processor (121) can apply the following Equation 4 (Back calculation Anti Wind up) to limit the output of the integrator in order to adjust for the error from Equation 3, and can perform an integrator update when the output (the accumulated control signal) reaches saturation.

$${\dot{x}}_{i} ( t ) = e ( t ) - {K}_{anti} \cdot ( u ( t ) - {u}_{sat} ( t ) ) \qquad [ Equation 4 ]$$

\dot{x}ᵢ(t) is the value with Anti-wind up applied, and Kₐₙₜᵢ is the gain value.

The updated F/F control can be based on the following Equation 5.

$$u ( t ) = {K}_{p} \cdot e ( t ) + {x}_{i} ( t ) + {K}_{d} \cdot \frac{d}{dt} e ( t ) \qquad [ Equation 5 ]$$

In Equation 5, the proportional and derivative terms operate like a conventional PID controller, and Anti-wind up can be applied only to the integral term. This allows the integrator's state to be adjusted through back-calculation, even when it is in a saturated state, thereby preventing integrator overshoot caused by saturation while maintaining controller performance.

Therefore, as shown in the following Equation 6, the processor (121) can obtain the control signal for controlling the EMB (130) in step S220 by applying a hybrid control method of F/F control and F/B control.

$$u ( t ) = {u}_{fb} ( t ) + {u}_{ff} ( t ) \qquad [ Equation 6 ]$$

u(t) is the control signal according to the hybrid control method, u_{fb}(t) is the control signal for F/B control, and u_{ff} is the control signal for F/F control.

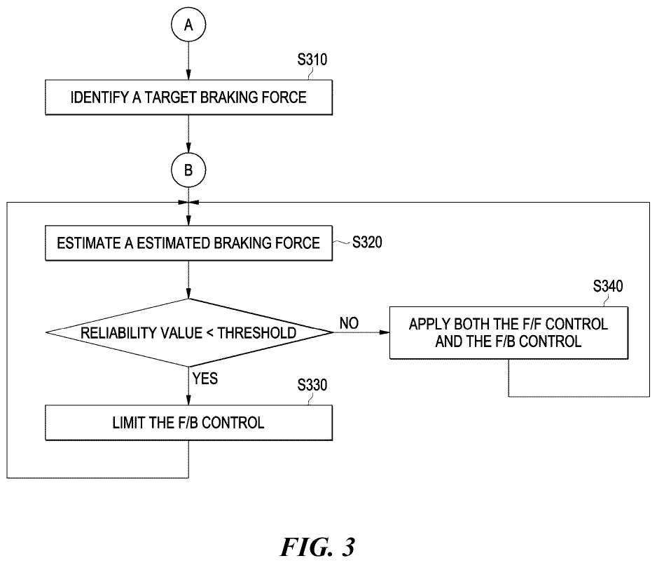

FIG. 3 illustrates the reliability evaluation flow of a brake system according to one embodiment.

As shown in FIG. 3, the controller (120) can evaluate the reliability of the F/F control (Feed Forward Control) and F/B control (Feed Back Control). The controller (120) can identify a target braking force based on the control command signal (S310).

The processor (121) can identify the target braking force required to brake the vehicle (1) according to the control command signal.

The controller (120) can determine the control result based on the control signal and the target braking force. And the controller (120) can estimate a estimated braking force (S320). Specifically, the controller (120) can evaluate the reliability of the control signal based on the estimated braking force and the target braking force.

For example, the estimated braking force can be estimated based on the wheel speed change and the vehicle's (1) weight, or it can be estimated based on the measured Clamping Force. The vehicle's (1) weight may be a preset weight according to the vehicle (1) model, and/or a weight estimated based on the driving current to a wheel driving device that rotates the wheel and the wheel speed change, but is not limited thereto and can be a value from various estimations and measurements.

In an embodiment, after controlling the driving current provided to the motor based on the control signal, the processor (121) can calculate the actual deceleration of the vehicle (1) based on the wheel speed signal. The processor (121) can estimate the braking force generated according to the control signal based on the actual deceleration and the weight of the vehicle (1). The processor (121) can evaluate the reliability of the corresponding control signal by comparing the estimated braking force with the target braking force. For example, the estimated braking force may be the actually generated braking force or the braking force estimated based on the output of a sensor. In another embodiment, if a clamping force sensor is provided in the brake system (100) and/or the vehicle (1), the processor (121) can identify the clamping force of the brake pad based on the clamping force signal. The processor (121) can estimate the braking force generated according to the control signal based on the identified clamping force.

For example, reliability can be an indicator of the reliability of the PID controller, calculated based on the difference between the target braking force and the estimated braking force. For example, reliability may be inversely proportional to the difference between the target braking force and the estimated braking force. The larger the reliability value, the closer the braking force generated by the output of the corresponding PID controller can be to the braking force required by the vehicle (1) (target braking force).

For example, to quickly respond to rapid target changes like in an ABS (Anti-lock Braking System), the controller (120) can improve the responsiveness of the brake system through the PID controller in the Pad Clearance (no-load) section and the section after the pad contacts the disc (load).

Specifically, the processor (121) can solve the difficulties associated with the constraints of using a clamping force sensor in the EMB (130) by implementing Force Estimation in software. For instance, the processor (121) can provide a feedback source to effectively implement Force Tracking control by solving the aforementioned difficulties through the PID controller. The role of this Force Estimation can be divided into Force Tracking in the processor's (121) judgment and calculation (in the following Equation 7). In the judgment process, the processor (121) can analyze the current state of the parking brake actuator to evaluate the reliability of the estimator. For example, based on the clamping force signal and the motor position signal, the processor (121) can estimate the temperature of the brake pad based on pre-stored reference data regarding the relationship between the currently generated braking force and the position of the brake pad. In the calculation process, the processor (121) can estimate the force through a mapping technique based on motor torque and motor position, and estimator blending using a Kalman Filter.

$$y = a \cdot f ( Torque ) + b \cdot f ( Position ) + c \cdot f ( Kalman ) \qquad [ Equation 7 ]$$

y is the target output, a+b+c=100% and f (Torque) is the output mapped to motor torque, f (Position) is the output mapped to motor position, and f (Kalman) is the estimated value using a Kalman filter.

In typical situations, since the vehicle (1) prioritizes starting braking, the brake system (100) of the present invention, in its basic control, uses a hybrid method that applies F/B control together with F/F control by trusting the estimation performance. However, if the reliability decreases, it can separate the F/B control and perform only F/F control.

Specifically, if the reliability is less than a preset threshold, the controller (120) can limit the control by the F/B control (S330) to separate the F/F control and the F/B control. At this time, the controller (120) can control the motor (131) by applying only the F/F control. Conversely, if the reliability is greater than or equal to a preset threshold, the controller (120) can control the motor (131) by applying both the F/F control and the F/B control (S340).

For this purpose, if the reliability is less than a preset threshold, the processor (121) can determine that the reliability of the estimation performance has degraded due to an increase in the error between the rigidity of the brake pad caused by temperature and control situations (e.g., ABS (Anti-lock Braking System) situation, ESC (Electronic Stability Control) situation, extremely low temperatures, etc.) and the rigidity in the pre-stored reference data, which is data measured in a lab. Accordingly, if the reliability is less than a preset threshold, the processor (121) can separate the F/F control and the F/B control and may not apply the second output from the F/B control in controlling the motor (131). At this time, the processor (121) can perform only F/F control and apply only the first output to the motor (131) control. As an example, the processor (121) can provide a signal regarding the reliability degradation to the integrated control unit of the vehicle (1) to output a warning through a warning device inside the vehicle (1) (e.g., display, speaker, mood lighting, etc.) and/or the driver's electronic device (e.g., smartphone, etc.).

Furthermore, the controller (120) can re-evaluate the reliability while the F/B control is limited. At this time, as a result of the re-evaluation, if the reliability is greater than or equal to a preset threshold, the controller (120) can release the limitation of the F/B control.

The processor (121) can evaluate the reliability in real-time and/or at regular intervals while the F/B control is limited and/or while only the F/F control is being performed. If the reliability recovers and is evaluated to be greater than or equal to the preset threshold, the processor (121) can again perform motor (131) control using a hybrid method that combines the F/F control and the F/B control.

Accordingly, in controlling the EMB (130), the brake system (100) of the present invention can change the form of the PID controller when the reliability degrades due to a severe error between the brake pad's temperature rise from friction between the disc and the brake pad in continuous ABS situations and the state of a conventional general brake pad (e.g., experimental results from a lab). It can then change the form of the PID controller again when the reliability recovers.

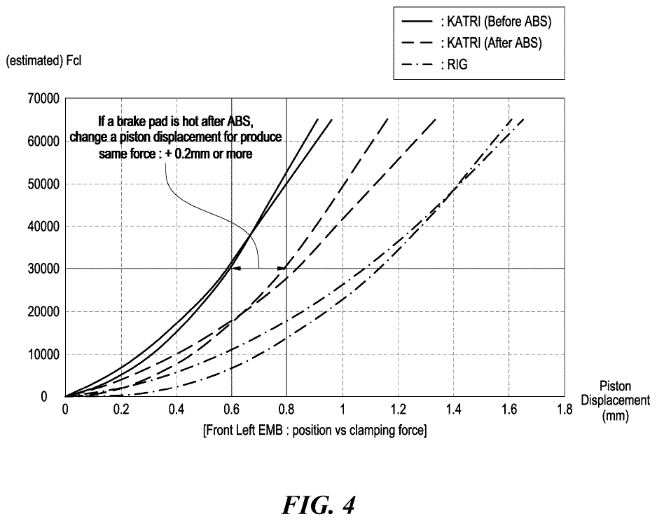

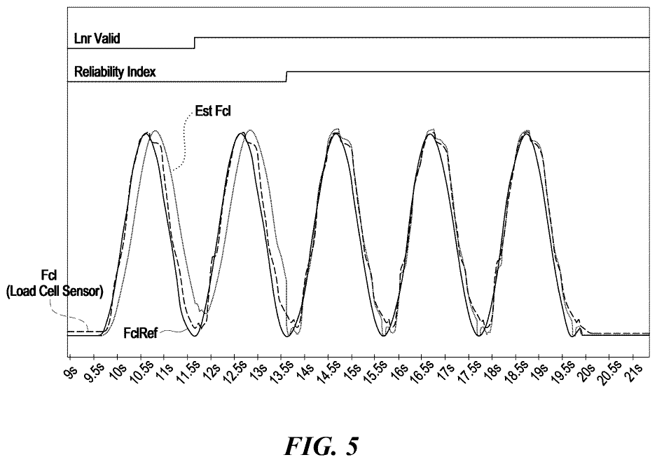

FIG. 4 illustrates an exemplary diagram of displacement variation in a rig environment of a brake system according to one embodiment, and FIG. 5 illustrates an exemplary diagram of reliability variation in a rig environment of a brake system according to one embodiment.

In this regard, referring to FIG. 4, as shown, when comparing the piston displacement (brake pad position) and the estimated Fcl (Force, clamping force) of the EMB vehicle, different results appear depending on the temperature state of the brake pad, and there is also a difference from the test data from the lab (RIG).

Referring to FIG. 5, even if a correction logic is applied to correct the Rig (Lab Data) test results (Fcl Ref, Reference Clamping Force) and the vehicle test results (Fcl, Clamping Force), it can be concluded that they differ depending on temperature and control situations. Therefore, in the conventional situation where the brake system (100) of the present invention trusts the estimation performance of the PID controller, since the vehicle prioritizes starting braking, the F/B control can be applied together with the F/F control. However, if reliability is measured and a degradation in reliability occurs, the brake system (100) of the present invention may not apply the F/B control to the control.

Accordingly, in the process of performing step S220, while performing braking force control and/or disc-pad distance control, the controller (120) can obtain a control signal for the control command signal by applying a hybrid control method that combines F/F control and F/B control as shown in Equations 1 through 6.

The processor (121) can obtain a control signal based on the first output and the second output while performing braking force control, disc-pad distance control, and/or parking control.

Meanwhile, in the process of performing step S230, when the controller (120) performs disc-pad distance control, it can perform position control for the brake pad, speed control for the motor (131), and/or torque control for the motor (131).

For this purpose, in the disc-pad distance control, the processor (120) can control the motor (131) based on the control signal to perform position control for the position of the brake pad in the EMB (130). For example, if first error data corresponding to an error through the position control is generated, the processor (120) can perform speed control for the motor (131) based on the first error data. If second error data corresponding to an error through the speed control is generated, the controller (120) can perform torque control for the motor (131) based on the second error data.

The brake system (100) of the present invention, by performing this cascaded control structure, makes it possible to precisely control the brake pad to perform translational motion to the required position and speed.

As an example, in the disc-pad distance control, the controller (120) can iteratively estimate the contact point of the brake pad based on a preset condition through the following Equation 8.

$$\frac{{dT}_{f}}{dt} = {C}_{1} ( {K}_{m} \frac{{dI}_{m}}{dt} ) - {C}_{2} ( {Y}_{t} \frac{{dF}_{a} ( θ )}{dt} ) - {C}_{3} ( J \frac{{d}^{2} ω}{{dt}^{2}} ) \qquad [ Equation 8 ]$$

$$\frac{{dT}_{f}}{dt} > Threshold ( C 1 , C 2 , C 3 : weigt factor ) ,$$

Kₘ, Yₜ, J are constants, T_{f} is the motor torque, Iₘ is the driving current, Fₐ(θ) is the clamping force of the brake pad based on the motor's rotation angle, and w is the motor's rotational speed.

To achieve this, the processor (121) can apply a Threshold-based decision Logic based on the threshold with the weighted values of C1, C2 and C3, as in Equation 8. Accordingly, the processor (121) can robustly update the pad contact point based on the state of the brake pad whenever a certain condition is met. This contributes to the processor (121) achieving Zero Drag by compensating for pad deformation and wear through Pad Clearance control.

In step S230, the controller (120) can control the motor (131) to stop the vehicle (1) based on the control signal.

For this purpose, the processor (121) can control the driving current provided to the motor (131) based on the control signal from the parking command signal, thereby controlling the parking brake to be engaged.

In this case, as an example, if the controller (120) identifies the occurrence of a fault due to incomplete engagement, it can re-perform the parking control.

Therefore, the processor (121) can determine the occurrence of a brake engagement fault due to incomplete engagement, etc., based on the clamping force signal, and can restart the motor (131) to re-perform parking control in the event of a fault.

As another example, if the vehicle (1) is in a parked state and wheel rotation is identified or the clamping force by the brake pad is below a threshold based on the estimated braking force, etc., the controller (120) can release the parked state of the vehicle (1) and re-perform the parking control.

Therefore, when the vehicle (1) is stopped and/or parked, the processor (121) can monitor the wheel speed signal and/or the estimated braking force, and if it determines that the stopped/parked state of the vehicle (1) cannot be maintained due to wheel rolling or a clamping force below the threshold, it can control the driving current provided to the motor (131) to separate the brake pad from the disc, thereby releasing the parked state of the vehicle (1). Once the parked state of the vehicle (1) is released, the processor (121) can control the driving current provided to the motor (131) to re-perform the parking control.

Meanwhile, the results of the single-unit test of the EMB's parking brake actuator using the F/F control and F/B control of the present invention showed that its responsiveness was on par with existing hydraulic and hybrid braking products. Furthermore, the single-unit test results showed that in terms of Accuracy, there were differences across different force ranges, with a performance disadvantage of approximately 7% compared to existing products at high forces. (In the case of the single-unit test, a target value (Clamping Force) generated via a Brake Pedal/Parking Switch/Signal Generator is sent to the brake actuator via CAN communication using a PC and communication equipment, and the brake actuator that receives it tracks the target value).

Additionally, the results of vehicle tests on an EMB vehicle (Hyundai Motor Company's mid-size electric sedan) using the F/F control and F/B control of the present invention showed that for normal braking (Service Brake), the performance was similar to existing braking products, and for ABS, it was on par with the performance of existing mass-produced vehicles. It was confirmed that even with the same EMB System, there was a difference in braking distance depending on the controller configuration. (In the case of vehicle tests, a hydraulic Emergency Brake was installed on the front wheels as a safety measure, and tests were conducted on the braking functions of the Service Brake and ABS).

Furthermore, the noisiest operation when driving the EMB system is the engagement/release function of the Parking brake. In the aforementioned vehicle tests, the noise generated by the EMB system during Parking engagement/release was largely masked by the vehicle's engine sound, and it was confirmed to be at a level that was difficult to perceive audibly.

Based on the single-unit test results of the parking brake actuator and the vehicle test results, it was confirmed that the EMB system's responsiveness, vehicle stability, and driving discomfort were in no way inferior compared to the braking performance of existing vehicles. In particular, it was proven that the problems of existing braking systems could be effectively improved in terms of Noise, Vibration, and Harshness (NVH). It was also confirmed that since the EMB system has motor-based characteristics, its initial responsiveness may be relatively slower than existing hybrid braking systems, but once the rotational motion begins, it shows a very fast response compared to existing systems, which can serve as a significant advantage for the EMB.

Meanwhile, the disclosed embodiments can be implemented in the form of a recording medium that stores computer-executable instructions. The instructions can be stored in the form of program code, and when executed by a processor, they can generate program modules to perform the operations of the disclosed embodiments. The recording medium can be implemented as a computer-readable recording medium.

A computer-readable recording medium includes all kinds of recording media that store instructions that can be interpreted by a computer. For example, there can be ROM (Read Only Memory), RAM (Random Access Memory), magnetic tapes, magnetic disks, flash memory, optical data storage devices, and so on.

The machine-readable storage medium can be provided in the form of a non-transitory storage medium. Here, ‘non-transitory’ means that the storage medium is a tangible device and does not include a signal (e.g., an electromagnetic wave), and this term does not distinguish between cases where data is stored semi-permanently and cases where it is temporarily stored on the storage medium. For example, a ‘non-transitory storage medium’ may include a buffer where data is temporarily stored.

The disclosed embodiments have been described above with reference to the attached drawings. A person of ordinary skill in the art to which the present invention pertains will understand that the present invention can be implemented in forms different from the disclosed embodiments without changing the technical spirit or essential features of the present invention. The disclosed embodiments are illustrative and should not be interpreted restrictively.

1. A brake system for controlling an EMB (Electro Mechanical Brake) provided on a vehicle wheel to provide braking force to the wheel, comprising:
a brake pad for applying frictional force to a disc provided on the wheel;
a motor for moving the brake pad; and
a controller for controlling the operation of the motor based on receiving a control command signal,
wherein the controller is configured to:
based on receiving the control command signal, outputs a control signal corresponding to at least one of braking force control, disc-pad distance control, and parking control to the motor to control the rotation of the motor, and
determines the application of at least one of F/F control (Feed Forward Control) and F/B control (Feed Back Control).

2. The brake system of claim 1, wherein the controller is configured to:
evaluates the reliability of the F/B control, and
if the reliability is less than a preset threshold, limits the control by the F/B control.

3. The brake system of claim 2, wherein the controller is configured to:
re-evaluates the reliability while the F/B control is limited, and
as a result of the re-evaluation, if the reliability is greater than or equal to a preset threshold, releases the limitation of the F/B control.

4. The brake system of claim 1, wherein the controller is configured to:
evaluates the reliability of the F/B control, and
if the reliability is less than a preset threshold, applies only the control by the F/F control.

5. The brake system of claim 4, wherein the controller is configured to:
re-evaluates the reliability while the F/F control is performed with the F/B control limited, and
as a result of the re-evaluation, if the reliability is greater than or equal to a preset threshold, applies the F/F control and the F/B control.

6. The brake system of claim 2, wherein the controller, evaluates the reliability based on a target braking force corresponding to the control command signal and an estimated braking force corresponding to the control signal.

7. The brake system of claim 1, wherein the controller is configured to:
obtains a first output by performing the F/F control corresponding to the control command signal,
obtains a second output by performing the F/B control corresponding to the control command signal,
generates the control signal based on the first output and the second output, and
performs an update for at least one of the F/F control and the F/B control to limit the upper and lower bounds of the accumulated control signal and to adjust for the error caused by the F/B control.

8. The brake system of claim 1, wherein the controller is configured to:
in the disc-pad distance control, performs position control for the position of the brake pad, and
if first error data corresponding to an error through the position control is generated, performs speed control for the motor based on the first error data.

9. The brake system of claim 8, wherein the controller, if second error data corresponding to an error through the speed control is generated, performs torque control for the motor based on the second error data.

10. The brake system of claim 1, wherein the controller is configured to:
in the parking control, controls the motor to stop the vehicle,
if a fault is identified, controls the motor to re-perform the parking control, and
in the parked state of the vehicle, if the rotation of the wheel is identified or the clamping force by the brake pad is less than a threshold, controls the motor to release the parked state of the vehicle and re-perform the parking control.

11. A control method for a brake system, provided on a vehicle wheel to provide braking force to the wheel, comprising a brake pad for applying frictional force to a disc provided on the wheel, a motor for moving the brake pad, and a controller for controlling the operation of the motor based on receiving a control command signal, the method comprising:
based on receiving a control command signal, outputting a control signal corresponding to at least one of braking force control, disc-pad distance control, and parking control to the motor to control the rotation of the motor; and
determining the application of at least one of F/F control (Feed Forward Control) and F/B control (Feed Back Control).

12. The control method for a brake system of claim 11, wherein determining the application further comprises:
evaluating the reliability of the F/B control; and
if the reliability is less than a preset threshold, limiting the control by the F/B control.

13. The control method for a brake system of claim 12, wherein the control method for a brake system further comprising:
while the F/B control is limited, re-evaluating the reliability; and
as a result of the re-evaluation, if the reliability is greater than or equal to a preset threshold, releasing the limitation of the F/B control.

14. The control method for a brake system of claim 11, wherein determining the application further comprises:
evaluating the reliability of the F/B control; and
if the reliability is less than a preset threshold, applying only the control by the F/F control.

15. The control method for a brake system of claim 14, wherein the control method for a brake system further comprising:
while the F/F control is performed with the F/B control limited, re-evaluating the reliability; and
as a result of the re-evaluation, if the reliability is greater than or equal to a preset threshold, applying the F/F control and the F/B control.

16. The control method for a brake system of claim 12, wherein the reliability is evaluated based on a target braking force corresponding to the control command signal and an estimated braking force corresponding to the control signal.

17. The control method for a brake system of claim 11, wherein controlling the rotation of the motor further comprises:
obtaining a first output by performing the F/F control corresponding to the control command signal;
obtaining a second output by performing the F/B control on the control command signal;
generating the control signal based on the first output and the second output; and
performing an update for at least one of the F/F control and the F/B control to limit the upper and lower bounds of the accumulated control signal and to adjust for the error caused by the F/B control.

18. The control method for a brake system of claim 11, wherein controlling the rotation of the motor further comprises:
in the disc-pad distance control, performing position control for the position of the brake pad; and
if first error data corresponding to an error through the position control is generated, performing speed control for the motor based on the first error data.

19. The control method for a brake system of claim 18, wherein performing the speed control further comprises:
if second error data corresponding to an error through the speed control is generated, performing torque control for the motor based on the second error data.

20. The control method for a brake system of claim 11, wherein controlling the rotation of the motor further comprises:
in the parking control, controlling the motor to stop the vehicle;
if a fault is identified, controlling the motor to re-perform the parking control; and
in the parked state of the vehicle, if the rotation of the wheel is identified or the clamping force by the brake pad is less than a threshold, controlling the motor to release the parked state of the vehicle and re-perform the parking control.
